(19) United States
(12) Patent Application Publication
(10) Pub. No.: US 2014/0172360 A1
(43) Pub. Date: Jun. 19, 2014

(54) Volume Measurement Using Non-Volumetric Sensors

(71) Applicant: IntraGrain Technologies Inc., Regina (CA)

(72) Inventor: Kyle Ronald Folk, Regina (CA)

(21) Appl. No.: 13/920,395

(22) Filed: Jun. 18, 2013

(30) Foreign Application Priority Data
Dec. 17, 2012 (CA) 2799060

(51) Int. Cl. G01F 17/00

(52) U.S. Cl. CPC G01F 17/00
USPC 702/156

(57) ABSTRACT

A method of volumetric monitoring for individual remotely located storage bins, in which a plurality of non-volumetric bin sensors are deployed for temperature or other monitoring. By monitoring the contact of particulate material stored within the bin with the non-volumetric bin sensors deployed therein, in relation to the positioning of those sensors within the height of the bin, the approximate level of filling of the storage bin can be monitored remotely by connecting the sensors to a location-based transceiver, which in turn communicates with a central monitoring system. The transceiver will monitor data received from the bin sensors and in accordance with predetermined notification conditions may send a signal to the central monitoring system when a notification condition, such as a depleted storage level within the bin, is detected.

This application claims foreign priority benefits from Canadian Patent Application 2,799,060, filed Dec. 17, 2012.

### FIELD OF THE INVENTION

The present invention relates to the storage of grain and other organic material in bins, and more particularly relates to the monitoring of the contents of such particulate material storage bins from the perspective of providing to a user an estimated level of filling of the bins, for theft or depletion detection purposes, using non-volumetric sensors which might otherwise be arrayed within the storage bin for temperature monitoring or other monitoring purposes.

### BACKGROUND

An issue of concern in agricultural industries, where grains are stored in storage bins, is the heating of the contents of those bins. Grain heating in storage bins can cause spoilage of the grain, resulting in diminished quality or full spoilage of the grain. Storage and high moisture or high heat environments can degrade or completely spoil these crops. Many efforts are made by farmers to minimize this possibility, and to maximize the price of their grain by enhancing and maintaining its top quality.

Storage bins are often located in close proximity to the fields where the crops are grown. In this way the grain can be stored until transport is required to a remote handling or dispatch facility, harvest. with minimum cost and time requirements during one of the traditional approaches to monitoring grain bin temperature conditions has been to travel to each bin and manually inspect the conditions of its contents. However where bins are geographically distributed, there are excessive costs and time commitments involved in traveling to each storage bin location. As well, given the distance and time involved in such travel, often the contents of the storage bins may not be checked as frequently as they should be to guarantee optimal storage of the product.

The use of remote monitoring solutions that employ in bin sensors is known. For example, U.S. Pat. No. 4,293,854 to Gookins et al. teaches a system in which in-bin sensors communicate bin conditions to a remote display device. However, the systems that have been created in this area to date have a significant limitation in terms of their ongoing operating costs insofar as if they use hardwired communications infrastructure to communicate with the central monitoring station this introduces a significant limitation in the locations that can be used [since hardwired communications infrastructure such as a telephone line or the like is required at that location].

While prior art systems are known that employ wireless technology to transmit grain bin conditions derived from in-bin sensors, the cost of such systems particularly in more remote locations can be prohibitive. Prior art systems teach constant sensing of bin conditions, and constant or at least periodic transmission of such data to a remote monitoring location. The result is a requirement for a substantial amount of transmission bandwidth, which can be very costly for the individual farmer or a company providing bin monitoring services, which cost can increase significantly in the case of more remote bin locations.

One of the problems encountered by farmers with storage bins remotely located around their property is the difficulty in accurately monitoring their contents over time from the perspective of even understanding what the approximate volume of product is that the farmer has on hand, where shipping to market is being delayed for economic hedging or other reasons. Solutions for monitoring the empty or filled capacity of storage bins at remote locations have similarly to the temperature monitoring systems outlined above typically been difficult to deploy and costly. Monitoring the capacity available in storage, or conversely monitoring the amount of product in storage, without significantly increasing the cost of monitoring for other spoilage conditions would be a desirable approach.

What is needed, therefore, is a method and system for remote monitoring of stored volume or capacity within grain bins at remote locations that uses pre-existing spoilage sensors within the grain bin. If there was a way to at a modest cost add the ability to monitor the stored volume or the empty capacity of a remotely located grain bin it is believed this would be desirable and accepted in the agricultural industry.

### SUMMARY OF THE INVENTION

The present invention seeks to provide a method and system for monitoring of storage bin capacity or stored or available volume in grain storage bins and the like, without the need for an additional set of volume sensors to be used within the bins to provide this information. Ideally it would be desirable to provide a storage bin capacity monitoring method and apparatus which provided volumetric feedback using non-Volumetric sensors which were otherwise deployed in the storage bins.

It will be possible to provide a volume monitoring method based upon the use of temperature monitoring sensors located within the remotely located grain storage bins. Other non-volumetric sensor types which were arrayed within a storage bin could also be used but many of the grain storage applications and remote monitoring grain storage applications include a series of temperature monitoring sensors which would be placed within the material stored within the bin and which could with the appropriate repurposing and head end programming be used to also provide some storage capacity feedback to the proprietor at the remote location, within the scope of a remote monitoring application to monitor temperature change within the stored material in the bin.

According to one aspect of the invention there is provided a method of monitoring a stored volume of material in a storage bin, the method comprising:

providing at least one non-volumetric bin sensor in the storage bin so as to be arranged to sense a non-volumetric attribute of material stored within the bin by proximity of the sensor to the stored material and a controller in communication with said at least one non-volumetric bin sensor so as to be arranged to receive the non-volumetric attribute sensed by said at least one non-volumetric bin sensor;

determining a proximity condition of said at least one non-volumetric bin sensor relative to the stored material based upon the non-volumetric attribute sensed by the non-volumetric bin sensor;

calculating a stored volume of material within the storage bin based upon the determined proximity condition of said at least one non-volumetric bin sensor and a location of said at least one non-volumetric bin sensor within the storage bin; and

using the controller to transmit one of the sensed non-volumetric attribute of said at least one non-volumetric bin sensor, the proximity condition of said at least one non-volumetric bin sensor, or the calculated stored volume to a monitoring location.

According to a second aspect of the present invention there is provided a monitoring system for monitoring a stored volume of material in a storage bin, the system comprising:

at least one non-volumetric bin sensor in the storage bin so as to be arranged to sense a non-volumetric attribute of material stored within the bin by proximity of the sensor to the stored material;

a monitoring system;

a controller including a memory storage and a processor configured to receive a signal from said at least one non-volumetric bin sensor indicating the non-volumetric attribute sensed by said at least one non-volumetric bin sensor and configured to transmit the sensed non-volumetric attribute of said at least one non-volumetric bin sensor to the monitoring system;

one of the monitoring system and the controller being further configured to determine a proximity condition of said at least one non-volumetric bin sensor relative to the stored material based upon the non-volumetric attribute sensed by the non-volumetric bin sensor and to calculate a stored volume of material within the storage bin based upon the determined proximity condition of said at least one non-volumetric bin sensor and a location of said at least one non-volumetric bin sensor within the storage bin.

Preferably there is provided a plurality of non-volumetric bin sensors in the storage bin, each at a respective height within the storage bin, and the sensors comprise temperature sensors arranged to sense a temperature of the material in the storage bin.

When there is a plurality of non-volumetric bin sensors in the storage bin, each at a respective height within the storage bin, and the method may further include determining a proximity condition of each sensor relative to the stored material by comparing the sensed temperature to the sensed temperature of other sensors. Alternatively, the method may further include determining a proximity condition of said at least one non-volumetric bin sensor by comparing the sensed non-volumetric attribute to a proximity criterion. The proximity criterion may be related to the sensed ambient temperature as sensed by an external ambient temperature sensor mounted externally of the storage bin.

The controller may be used to periodically sample the non-volumetric attribute sensed by said at least one non-volumetric attribute. In this instance, the controller may transmit either one of the sensed non-volumetric attribute of said at least one non-volumetric bin sensor, the proximity condition of said at least one non-volumetric bin sensor or the calculated stored volume to the monitoring location only if the sensed non-volumetric attribute of said at least one non-volumetric bin sensor has changed by a prescribed criterion amount.

When a monitoring system is provided at the monitoring location which is arranged to communicate with the controller, the monitoring system may be used to send a notification signal to a user in response to a change in the proximity condition of said at least one non-volumetric bin sensor.

In the instance of a monitoring system at the monitoring location, the controller may be used to sample the non-volumetric attribute sensed by said at least one non-volumetric attribute in response to a query signal from the monitoring system.

The monitoring location may comprise a user location associated with a single user, or alternatively, a central monitoring system at a central location associated with a plurality of users, each having at least one storage bin arranged to be monitored by the central monitoring system at the central location.

When the monitoring location is a single user location, the controller may be used to calculate the stored volume of material and transmit the calculated stored volume of material to the single user at the user location.

Alternatively, when the monitoring location comprises a central monitoring system, the controller may be used to either: i) calculate the stored volume of material and transmit the calculated stored volume of material to the central monitoring system at the central location, or ii) transmit either one of the sensed non-volumetric attribute or the proximity condition of said at least one non-volumetric bin sensor to the central monitoring system so that the central monitoring system can be used to calculate the stored volume of material. In the preferred embodiment the controller only transmits the sensed non-volumetric attributes to the central monitoring station and the central monitoring station determines the proximity condition and calculates the stored volume.

When a prescribed volume is associated with said at least one non-volumetric bin sensor, the stored volume may be calculated using the proximity condition and the prescribed volume of said at least one non-volumetric bin sensor.

Alternatively, when a prescribed height is associated with said at least one non-volumetric bin sensor, the stored volume may be calculated using the proximity condition of said at least one non-volumetric bin sensor, the prescribed volume of said at least one non-volumetric bin sensor, and a cross-sectional area of the bin.

According to another aspect of the present invention there is provided a method for remotely monitoring storage capacity or stored volume of a storage bin, comprising the steps of: (a) providing at least one non-volumetric bin sensor in the storage bin for sensing a non-volumetric attribute of the material stored within the bin, such as temperature, by engagement or proximity of that bin sensor or bin sensors to the material stored; (b) allowing the non-volumetric bin sensor to transmit the sensed non-volumetric attribute to a transceiver; (c) calculating the stored volume of material within the storage bin based upon the total storage volume of the storage bin and the location of the bin sensor or sensors engaged by the stored material within the storage bin; and (d) transmitting either the details of the bin sensors engaged by material within the bin, or the calculated stored volume of material within the storage bin, or both, to a user locally or to a central monitoring system through a transceiver operatively connected to the non-volumetric bin sensors.

The method can be used with multiple bins and sensors, and the transceiver can receive data from all connected sensors. The connection between the sensor and the transceiver can be either wired or wireless. Either at the transceiver or at a remote monitoring station the stored volume within the storage bin can be calculated based on the predetermined or known total volume and geometry of the storage bin and the location of the individual non-volumetric bin sensors therein. Specifically, for example, where a temperature monitoring cable is placed within a storage bin that contains a plurality of temperature sensors along its length, it is possible to calculate the approximate stored volume within the storage bin by knowing the sensor or sensors within the temperature monitoring cable which are engaged by stored material. Each non-volumetric bin sensor, within that table in this example, defines the top edge of a cross-sectional slice of the storage bin and it is possible to generally forecast or understand the stored volume within the storage bin based upon which cross-sectional slice or slices of the volume thereof contain particulate material. The level of granularity of this particular volume measurement or volume forecasting method will be improved as the number of non-volumetric bin sensors displaced along the height of the storage bin is increased—while this method may not provide scientific accuracy it will provide a good basis to remotely monitor the approximate stored contents of storage bins at a remote location.

There are two measurement methods in terms of the actual calculation of the stored volume of material in the storage bin. An additive calculation can be made by adding up the calculated total volumes of each individual volumetric cross-section of the storage bin defined on its top plane by a bin sensor engaged by stored material, or an aggregate identification or calculation can be made by simply calculating the volume of a single aggregate volumetric cross-section defined in its top plane by the highest bin sensor engaged by stored material and defined at its bottom plane by the bottom of the bin. Variations on these calculation methods will be understood to those skilled in the art and are also contemplated within the scope hereof.

To accommodate measurement or reflection of the potential of stored material which might be above the highest bin sensor engaged by stored material and below the next adjacent highest sensor, the calculation of the total stored volume could be adjusted.

According to yet another aspect of the present invention there is provided a system for remotely monitoring the stored volume of material within a storage bin, the system comprising: at least one non-volumetric bin sensor for provision within a bin, the sensor configured to sense the internal temperature or another attribute of material stored therein; a transceiver configured to receive a signal from the at least one bin sensor indicating the sensed internal temperature or other attribute of stored material in proximity or in contact with that bin sensor; the transceiver configured to communicate the sensed internal temperature or other attribute of material stored within the bin and within proximity or contact with that bin sensor or sensors, through a communication network to a central monitoring system.

In preferred embodiments, the system includes multiple bins and bin sensors. In preferred embodiments, the system also comprises means to enable access to the transmitted data through data display at the central monitoring system, and/or data access at other locations through the communication network.

A detailed description of exemplary embodiments of the present invention are given in the following. It is to be understood, however, that the invention is not to be construed as being limited to these embodiments.

One embodiment of the invention will now be described in conjunction with the accompanying drawings in which:

### BRIEF DESCRIPTION OF THE DRAWINGS

FIG. 1 is a diagrammatic illustration of a grain storage bin, intended to demonstrate the additive stored volume detection method outlined herein;

FIG. 2 is a diagrammatic illustration of a grain storage bin, intended to demonstrate the aggregate stored volume detection method outlined herein;

FIG. 3 is a flowchart illustrating the steps of one embodiment of the additive stored volume detection method outlined herein;

FIG. 4 is a flowchart illustrating the steps of one embodiment of the aggregate stored volume detection method outlined herein;

FIG. 5 is a flowchart illustrating the steps of one embodiment of the volume change detection method outlined herein; and

FIG. 6 is a system diagram showing the components of one embodiment of a remote storage monitoring volume system in accordance with the present invention.

Exemplary embodiments of the present invention will now be described with reference to the accompanying drawings.

In the drawings like characters of reference indicate corresponding parts in the different figures.

### DETAILED DESCRIPTION

Referring now to the accompanying drawings, embodiments of a method and system according to the present invention are illustrated.

### Overview

As outlined above, the general concept of the present invention is to provide a method and related apparatus for the remote monitoring of the stored volume of material within a storage bin at a remote monitoring location, while at the same time monitoring temperature or another attribute of particular material storage therein. Specifically it is contemplated that this method and apparatus would be used with respect to remotely located grain storage bins although storage of other types of particulate material could also be monitored in this fashion.

Provision of a method and apparatus for monitoring or calculation of the stored volume within remotely located storage bins while at the same time monitoring the temperature or other attributes of the material stored therein, without the need for specifically incorporating volumetric sensors into the storage bins i.e. using non-volumetric sensors deployed for another purpose within the bin—is the core of the present invention. A method of providing an approximation or measurement of the volume of stored material contained within such a storage bin, whether that be at a remotely located storage site or even at a location local to the user, which used non-volumetric bin sensors which were otherwise already in place, would provide a reasonably priced additional instrumentation option for farmers and agricultural producers, or others using particulate material storage bins.

At a monitoring location, one or more grain or particulate storage bins is each fitted with at least one non-volumetric bin sensor for the purpose of monitoring and reporting the temperature or another attribute of material stored within that bin. These non-volumetric bin sensors are each connected to a head-end transceiver capable of receiving temperature or other attribute readings from those sensors, and in the case of a local embodiment calculating the stored volume of material within the bin and displaying that to the user, or in a remotely monitored embodiment transmitting or communicating that information with the central monitoring station.

The non-volumetric bin sensors will be placed along or in relation to the vertical dimension of the storage bin, such that each bin sensor defines the upper horizontal edge of a volumetric cross-section of the storage bin. The approximate volume of material stored within the storage bin can be calculated based upon knowing what highest bin sensor within the storage bin is engaged or proximate to the upper surface of the stored material within the bin. An approximate volumetric calculation can be made based upon the cross section of the bin and the stored height of material within the bin.

Periodic reporting of the level of stored material within storage bins can also be used by the farmer to detect theft or other problems resulting in the depletion of material stored within a particular storage bin. Rapid increase in the storage level within the bin might be something that also would be needed to be detected in certain remote for industrial applications and the method of the present invention with a periodic reporting frequency are testing frequency outlined herein could be used for that purpose as well.

It is specifically contemplated that one type of a non-volumetric bin sensor which would be used for the volume measurement method of the present invention would be a temperature sensing cable such as is otherwise used in grain bin storage monitoring applications. The cable, which is installed from the floor to the roof of the bin, has a plurality of temperature sensors disposed there along, each of which temperature sensors is effectively located within a “zone” of stored material when the bin is filled with grain or other material around the cable. So long as the transceiver which is connected to that cable is capable of detecting the specific bin sensor or sensors which are immersed or proximate to stored material, the volume cross-sections of the storage bin which are filled can be defined, detected, and totalled for the purposes of determining the approximate level of filling or stored volume within that storage bin.

When using temperature sensors, a proximity condition of each sensor relative to the stored material, that is the determination as to whether a sensor is engaged by the particulate material in the bin or not, may be determined by various means. For example the sensed temperature of each sensor can be compared to the sensed temperatures of other sensors and a given sensor is considered to be engaged by material if its temperature falls within a prescribed threshold relative to the other sensors.

Alternatively, each sensor may be considered to be engaged by material within the bin if the sensed temperature meets certain prescribed criterion. In another instance, if the sensed temperature of one sensor varies by an amount which meets or exceeds a prescribed fluctuation threshold over an elapsed period of time, such as a twelve hour period between day and night for example, then the sensor may be considered to be not engaged by material.

In a preferred embodiment, an ambient temperature sensor is provided externally of the bin and in communication with the controller so as to be arranged to sense the ambient temperature and relay the sensed ambient temperature to the controller for use in determining the proximity condition either at the controller or at the central monitoring system. The prescribed criteria against which other sensed temperatures are compared to in determining the proximity condition in this instance includes the ambient temperature. When determining the proximity condition at the central monitoring station, the ambient temperature is transmitted with the sensed temperatures of the in-bin non-volumetric sensors whenever a notification condition is determined.

Many types of sensors which were mounted along the wall of the storage bin, or otherwise in the bin, could all be used, so long as the vertical location of the bin sensor in relation to the vertical axis of the storage bin itself was known from the perspective of defining the horizontal upper and lower boundaries of the volume cross-sections defined thereby.

In addition to the aggregate or additive methods of calculating stored volume in a storage bin outlined herein using non-volumetric bin sensors, a remote monitoring system which incorporates the ability to remotely monitor the stored capacity of storage bins therein is also contemplated. This system comprises several components including, at each remote monitoring location which was desired to be equipped or monitored in accordance with the method of the present invention, at least one non-volumetric bin sensor within each storage bin which was desired to be monitored, the vertical position of the temperature sensor within the storage bin defining the top of at least one horizontal volumetric cross-section of the storage bin. The non-volumetric bin sensors, for temperature or the like, would in turn be operatively connected to a transceiver located at the monitoring location which was capable of monitoring the temperature or other material attributes in the storage bins via the non-volumetric bin sensors displaced therein, and providing that feedback to the transceiver. In addition to a communication bus which would enable communication with sensors located within individual storage bins, the transceiver would also be equipped to communicate with a central monitoring system in central monitoring location such that when the transceiver was queried for the volume levels of one or more storage bins thereat, the indication of the highest non-volumetric bin sensor within the bin to be measured for volume stored would be captured and the system could calculate the stored volume of material within the storage bin based upon knowing the vertical location of the highest obscured bin sensor within the bin along with the volumetric geometry of the bin, such that the “filled” volumetric cross-sections of the bin below the highest obscured sensor could be totalled up for the purposes of determining the stored volume, or alternatively or conversely the available volume storage remaining in the storage bins.

The central monitoring system might also be capable of dispatching outgoing communications to users if a trigger event was detected, such as a unanticipated or detected depletion or increase of volume of stored material within a particular storage bin, and/or some other type of notification is required.

### Non-Volumetric Bin Sensors

As outlined elsewhere herein, the key aspect of the present invention is the provision of a method for the calculation or measurement of the volume of stored material within the storage bin, using non-volumetric bin sensors already placed in the bin in relation to the vertical axis of the bin. There are many different types of bin sensors which could be used for other types of material monitoring within a storage bin for grain or other similar organic material, which could be double purposed in accordance with the method of the present invention.

Many storage bins in the agricultural sector are already fitted with temperature sensors in various zones within the bin to allow for the monitoring and avoidance of spoilage of the material by heating. Practicing the method of the present invention using binary or non-volumetric feedback from temperature sensors is specifically contemplated to provide a great economic advantage. Many types of temperature sensors which are capable of detecting the temperature within a storage bin or a particular zone of stored material within the storage bin have been used in the past in grain bin temperature monitoring applications.

The key to the types of non-volumetric sensors which are contemplated is that they are mounted in particular locations in relation to the vertical axis of the storage bin. Also, the non-volumetric bin sensors, for temperature measurement or the like, would be capable of connection and communication with the transceiver. In fact it is desired and outlined elsewhere herein to provide a transceiver and the remainder of the present system that could interchangeably be used to provide feedback on temperature or other attributes of stored material along with an indication of stored material volume. It is explicitly contemplated that one type of the sensor which would be used in the method of the present invention is a temperature sensor cable such as has been developed and used in the past, which is effectively a cable that is installed down the center of a grain bin with a plurality of temperature sensors displaced therealong, equidistant or otherwise. By connecting that cable to a transceiver, the individual temperature sensors within the cable can be read.

The specific type of a reading which is required from the non-volumetric bin sensors in order to practice the method of the present invention is in its most basic form of binary feedback result indicating the proximity or immersion of a particular sensor in stored material within the bin. This type of a result would also be achieved or reached by treating a positive non-volumetric attribute reading from a sensor as a binary “yes” or “true” from the perspective of an indication of the proximity of the stored material to that particular sensor—for example if a temperature sensor returns a temperature reading from the material which is in proximity thereto, that sensor reading can be treated as a “true” from the perspective of an indication of the height of material within the bin.

The non-volumetric bin sensors, for measurement of temperature or otherwise, could be connected either wirelessly or in a hardwired fashion to the transceiver or head end hardware which would read those sensors. In some instances the sensors communicate directly with the transceiver for transmission to the central monitoring system, whereas in other instances, the sensors communicate through respective intermediate remote units to the transceiver so that the transceiver aggregates data from the sensors of several remote units prior to transmission to the central monitoring system. It is specifically contemplated herein that the detection of temperature or other attributes within individual zones within the bin and the related sensor materials required therefore, will be key to the accomplishment of the volume forecasting or measurement of the present invention.

### Temperature Sensor Cable

One of the specific types of non-volumetric bin sensors which would be used are temperature monitoring cables which in a grain bin storage context are used to monitor or avoid internal heating of the stored material within these bins etc. Temperature sensors are displaced at numerous heights or locations along the cable, which is extended from the floor of the storage bin to the ceiling, such that extension of the temperature sensor cable from the floor to the ceiling of the storage bin, and wired such that each sensor can be separately monitored or measured with an appropriately configured head unit.

Individually wired and placed sensors could also be used rather than those placed along a cable, so long as the remainder of the hardware used in the method of the present invention was capable of connecting to and reading from all of those sensors.

### Measurement Methodology

The underlying method of the present invention is to provide a means of measurement of the approximate volume of material stored within a storage bin, using non-volumetric sensors that would otherwise be deployed within the bin for this purpose. The key to the use of non-volumetric bin sensors for measurement of stored volume or available storage volume within a storage bin such as this is that the non-volumetric bin sensors, either by contact, immersion or proximity to material stored within the bin or otherwise, have the ability to render a presence indication related to stored material at or near each such sensor. On that basis, the underlying premise is that a temperature sensor, humidity sensor or the like, could be used to contribute to a volume calculation based upon the presence of stored material around or near that sensor. By knowing that that sensor is immersed in material, the farmer can know that the bin is filled at least up to that level with material. By then also knowing the location of each such bin sensor within the bin and the volumetric geometry of the bin, the volume cross-sections of the bin which are defined along the vertical axis of the bin by the location of each non-volumetric bin sensor can each be detected as filled or empty, and the filled volumes of those volume cross-sections totaled up to render an approximate stored volume of material within the bin.

The key to the method of the present invention is that the location of the non-volumetric bin sensors along the vertical axis of the storage bin will need to be known, so that they can be programmed into the mathematics which are used to determine the stored volume. For example in a flat bottomed bin, if temperature sensors are located every foot from the floor to the ceiling, the highest bin sensor which is obscured by stored material would define the highest 1 foot volumetric section of the bin which is filled and which would be totaled up for the provision of an approximate stored volume total. By the provision of bin sensors in this particular example, the bin would effectively be divided into a plurality of 1 foot tall sections, and the math which was associated with determining the stored volume within a 1 foot section of the bin could be used then too, based on the number of sensors which were covered bystored material, determine our render the stored total volume within the bin.

While it is necessary to understand the location of each non-volumetric bin sensor in relation to the height of the bin, and more specifically in relation to the specific volume cross-section to which it pertains, the other key mathematical item which would be necessary to be understood in an individual bin implementation of the method of the present invention would be to understand that volumetric geometry of the bin. A storage bin which had a consistent shape, whether that be square, round or otherwise, would be the simplest for calculation of stored volume since the calculation of stored volume would effectively comprise multiplying the surface area of the bin by the height of the highest sensor in the bin which was obscured by material stored.

Each of the non-volumetric bin sensors, at its vertical height within the storage bin, would define the top horizontal plane of a volumetric cross-section of the storage bin. For example the first bin sensor above the floor of the storage bin would demarcate a volumetric cross-section defined on its bottom by the floor of the bin, around its outside by the walls of the bin, and at its top by the vertical height or location of the bin censoring question. It is then possible to simply calculate the volume of that particular volumetric cross-section of the storage bin and when the bin sensor defining the top plane of that volumetric cross-section is engaged by stored material, it is known that at least that volume of material is stored within the bin. The second bin sensor, located above the first, would define another volumetric cross-section defined on its bottom plane by the first bin sensor, on its top plane by the second bin sensor and again around its edges by the walls of the storage bin.

There are two mathematical approaches to calculating the volume of stored material within the storage bin based on the binary feedback required from the non-volumetric bin sensors—either being engaged or unengaged by stored material. For the sake of description and further discussion, they are referred to herein as the aggregate measurement method and the additive measurement method.

Looking first at the additive measurement method, the approximate stored volume of material within the storage bin is determined by adding up the volume of each occupied volumetric cross-section of the storage bin, based on the determination of which of the non-volumetric bin sensors within the bin each of which corresponds to a particular volumetric cross-section is in contact or proximity to stored material. By determining which of the volumetric cross-sections within the storage bin are occupied by material, the approximate stored volume of material within the bin can be determined by simply adding those up.

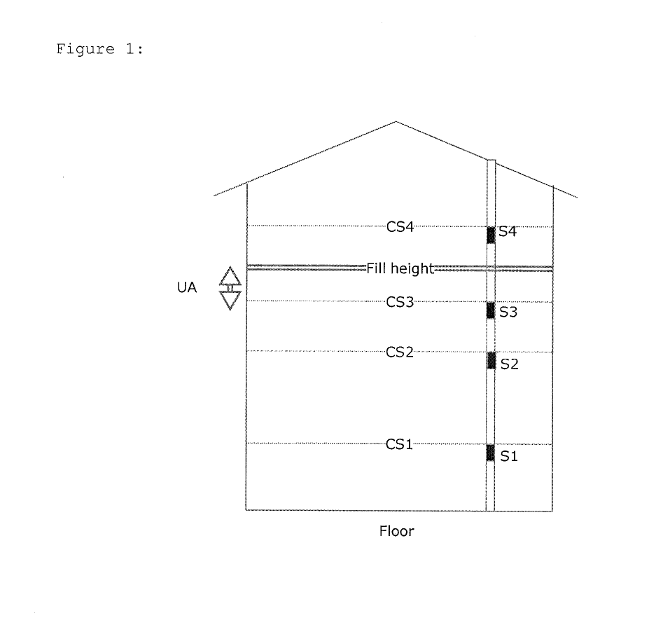

FIG. 1 is provided to demonstrate the hardware in a particular embodiment of the present invention as well as to demonstrate the attitudes volume measurement approach. There is shown a grain bin, with the floor. Also shown within the bin is a temperature sensor cable with a plurality of non-volumetric bin sensors, being temperature sensors, displaced therealong. These sensors are numbered S1, S2, S3 and S4. The temperature sensor cable would be connected to head end hardware capable of capturing the non-volumetric attribute readings of the sensors within the bin—in this case the temperature readings of each of those sensors. The head end hardware is not shown in this case.

As discussed above, each of the non-volumetric bin sensors S1 through S4 defines the top plane of a volumetric cross-section of the storage bin. In this case the volumetric cross-sections of the storage bin defined by these four sensors are shown with dotted lines as CS1, CS2, CS3 and CS4. For the sake of demonstration, the temperatures sensors along the cable are not all equidistantly spaced although they could be and perhaps most likely would be—by showing them non-equidistantly spaced it is intended simply to demonstrate the flexibility of the method of the present invention. Cross-section CS1 would be defined by the outer walls of the storage bin and the bottom plane of that cross-section would be the floor of the grain bin with the top plane being the sensor S1. Cross-section CS2 would be defined by the outer walls of the storage bin, with the bottom plane of that volumetric cross-section being the plane defined by sensor S1 and top plane of that volumetric cross-section being the plane defined by sensor S2. Similarly, crosssection CS3 would be defined in its top plane by sensor CS3, and CS4 defined in its top plane by sensor S4.

Stored material is shown within the bin. In the case of the stored material which is shown in this case, by the fill height in this case the storage bin is filled to a point between sensors S3 and S4.

In the additive measurement method, what would be done to determine the volume of stored material within the storage bin would be to capture a set of temperature readings, or other non-volumetric attribute readings, from the bin sensors. In this case, temperature readings related to the stored material would be captured from sensors S1 through S3. Either by treating a temperature attribute indication as a binary value indicating presence of the material in proximity to that sensor, or by a specific proximity reading, the method of the present invention would treat the readings from these non-volumetric bin sensors as indications that the volumetric cross-sections corresponding to the sensors providing these readings were each full of stored material. In this case then since sensors S1 through S3 would provide a positive proximity indication, cross-sections CS1, CS2 and CS3 would be identified as full and the calculated volumes of each of those volumetric cross-sections of the storage bin would be added up to yield the approximate stored volume within the storage bin.

As outlined elsewhere herein, increased granularity can be accomplished in the method of the present invention by increasing the number of bin sensors. This would minimize the amount of unmeasured aggregate material, shown as UA in FIG. 1. It would be a known limitation of the method of the present invention that the next volumetric cross-section above the last sensor reading in contact with the stored material could contain additional stored material. The calculation of the present invention could be modified to for safety or other purposes and the storage volume of the next volumetric cross-section above the highest contacted bin sensor—in this case cross-section CS4—to the total calculated stored material so that the bin would not be overfilled etc. either approach to the calculation of material stored within the storage bin i.e. factoring in or not factoring in the possibility of unmeasured aggregate material above the highest contacted bin sensor, will be understood by those skilled in the art and is contemplated within the scope of the present invention.

The head end hardware attached to the sensors/sensor cable at the grain bin could be programmed to render the volume or storage calculation, or the readings from the various non-volumetric bin sensors could be communicated from the transceiver hardware to a remote location at which point the volume could be calculated or displayed. Either such approach is contemplated herein. It is even contemplated that the existing software on head end hardware intended for monitoring the temperature or other non-volumetric attributes of sensors predisposed within the storage bins for grain and the like could be modified to allow for the addition of this type of a storage readout. Either in the local hardware or at the remote monitoring site, the attributes which would need to be programmed into the system for the purposes of the present method would be to identify the cross-sectional area of the storage bin, and the vertical height within the storage bin of each non-volumetric bin sensor.

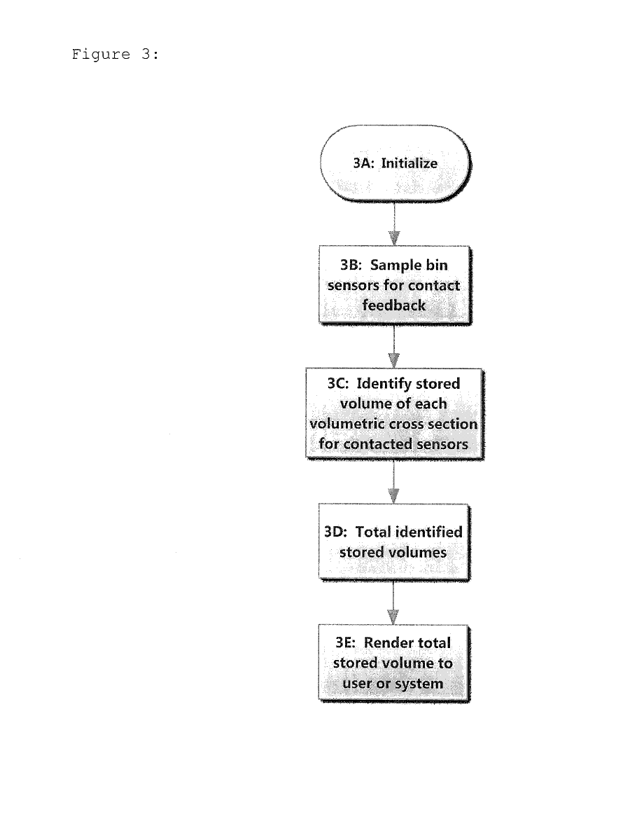

FIG. 3 is a flowchart showing the steps involved in the additive calculation method of the present invention. Shown at step 3A is the initialization of a particular sampling or calculation run. The first step of the method, shown at 3B, is to sample each of the non-volumetric bin sensors within the bin to obtain their attribute readings. Whether that be temperature, humidity or otherwise, these readings can otherwise be used by the user and are the basis for the calculation. Based upon obtaining those non-volumetric attribute readings from the bin sensors, the presence of stored material within an individual volumetric cross-sections within the bin defined on their top plane by each of those bin sensors can be determined.

Based upon the acquisition of readings from the bin sensors, the stored volume for each occupied volumetric cross-section of the storage bin can be identified (3C). As outlined elsewhere, based upon the acquisition of a valid attribute reading from a bin sensor, for the purpose of the method of the present invention the volumetric cross-section defined on its top plane by that particular bin sensor will be treated as full or occupied. The calculated stored volume for each volumetric cross-section of the storage bin defined by a sensor could be calculated on the fly each time, or could be calculated when the system was set up such that they could simply be totaled each time. In the case of a retrofit system, it may be simpler to calculate at set up the stored volume of each volumetric cross-section and simply map that into the hardware in relation to each bin sensor but all such approaches to this aspect of the calculation process will be understood to those skilled in the art and are contemplated within the scope of the present invention.

Having identified the filled storage volume for each occupied volumetric cross-section of the storage bin corresponding to a contacted or immersed bin sensor, the approximate total stored volume within the storage bin can be calculated by totaling those individual storage volumes—shown at 3D. The calculated additive total stored contents of the storage bin would then be displayed to the user or otherwise used in a monitoring system, shown at 3E.

The second approach to measurement, rather than the additive approach outlined with respect to FIG. 1 and FIG. 3, is the aggregate measurement approach which is also outlined herein.

The primary difference between the additive approach and the aggregate approach to determining the stored volume within a storage bin is to treat each of the non-volumetric bin sensors is defining the top plane of a volumetric cross-section of the bin which is always defined on its bottom plane by the floor. As such then the only thing that needs to be determined for the sake of measuring volume stored within the bin is which is the highest bin sensor which is contacted by stored material, and then the aggregate cross-section of the bin corresponding to that sensor would provide the approximation of stored material volume.

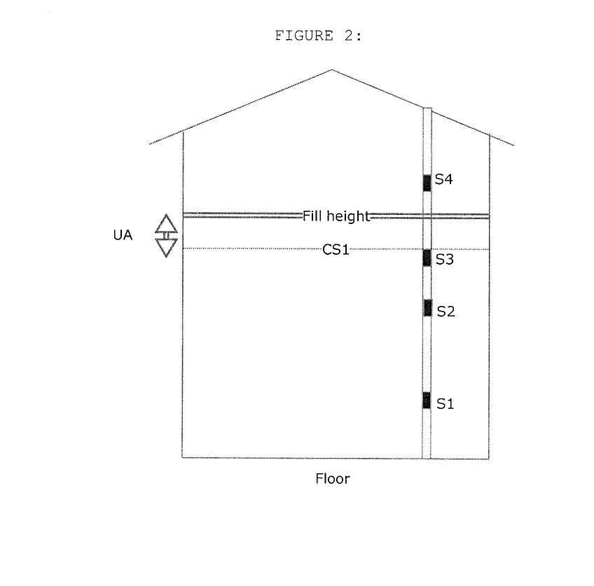

FIG. 2 is provided to illustrate the aggregate calculation approach of the present invention. There is again shown a grain bin with a floor and a sensor cable mounted therein which contains four sensors S1, S2, S3 and S4. Head end hardware for the reading of the sensor cable etc. again is not shown but will be understood based on the remainder of the disclosure herein.

In the aggregate calculation method there will only be a single relevant volumetric cross-section of the storage bin based upon the level of stored material contained therein. The relevant volumetric cross-section will be defined on its bottom plane by the bottom of the storage bin and on its top plane by the highest bin sensor contacted by the stored material therein. Either based on a stored predetermined number or alternatively based on a calculation done on the fly the volume of that single aggregate volumetric cross-section can be determined and provided by way of feedback to the user for an estimation of stored material volume within the storage bin.

As indicated with respect to the additive method above, there is the issue of dealing with or forecasting the amount of stored material within the bin above the highest sensor, which in this case is S3. Various means of doing this will be understood by those skilled in the art for example, the method could automatically take the next highest non-contacted sensor which in this case would be S4 to render the calculation or indication of stored material volume which would ensure that the bin for example was not overfilled or the like, or the margin of error defined by that next highest volumetric cross-section defined by those two sensors being the highest sensor contacted in the next highest sensor not contacted by the stored material could simply be factored into the use of the system. Again adjusting the stored volume indication in this regard is contemplated within the scope hereof.

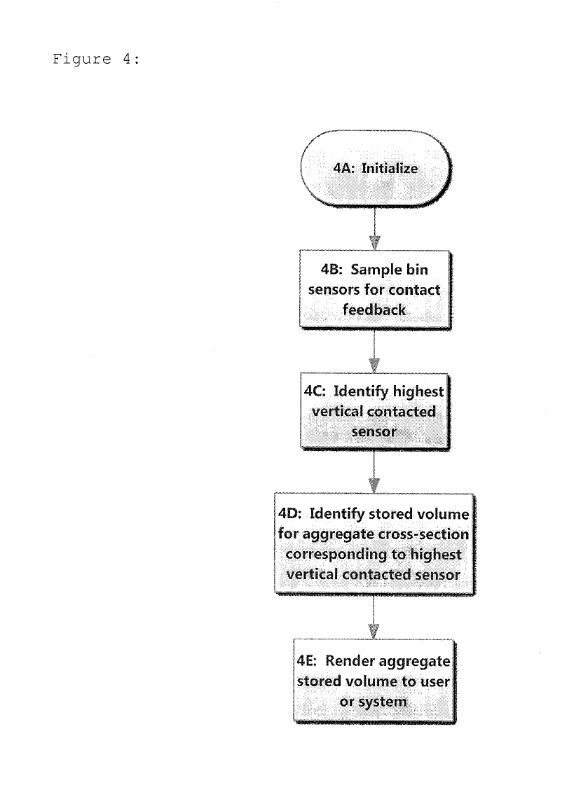

FIG. 4 is a flowchart demonstrating the aggregate method of volume calculation within the storage bin based on the outline herein. Following the initialization of the method, shown at 4A, each of the non-volumetric bin sensors will be sampled to provide their attribute reading, again on the basis that either a valid attribute reading or even a specific binary proximity feedback with respect to material stored in the storage bin will be treated as an indicator for the purposes of the present method—sampling of the sensors is shown at 4B.

From the bin sensors having provide a positive proximity or contact feedback, the highest bin sensor within the bin, which is in contact with stored material, will be identified 4C. the aggregate volumetric cross-section of the storage bin below that sensor, defined in its top plane by that highest bin sensor engaged with material and on its bottom plane by the floor of the storage bin, would then be the stored volume of material which is fed back—4D, 4E. As in the case of the additive method outlined above the volume of the relevant aggregate volumetric cross-section could be calculated once the sensor was identified, or in some cases the aggregate volume of the cross-section corresponding to that particular sensor could be stored within the head end hardware or elsewhere in the monitoring system for simple retrieval and feedback without the need for calculation on the fly.

It will be understood that both the aggregate and additive methods of calculation outlined herein achieve the same result of allowing to estimate the volume of stored material within the storage bin based upon or using a plurality of non-volumetric bin sensors placed within the storage bin and that both such approaches and methods as outlined herein, with such modifications, refinements or enhancements as are obvious to those skilled in the art, are contemplated within the scope of the present invention.

### Notification of Rapid Change in Stored Material Level

In addition to providing, based upon periodic data sampling from the storage bins or a triggered query for response, an indicator of the approximate volume of stored material contained within one or more storage bins in accordance with the methodology of the present invention, there is also provided herein a method for theft detection at remote locations in grain storage bins and the like, based upon the detection of a rapid depletion in the stored volume of material within the bin. The converse would also be true wherein notification of rapid increase in the volume of stored material could also be notified, in addition to a rapid depletion or decrease a rapid increase might be an indicator of a problem in a remotely located industrial application etc.

In an implementation of the volume measurement methodology of the present invention, what would be required in order to provide a theft detection or rapid depletion feedback to users would be to implement a system by which the non-volumetric bin sensors within the storage bin or bins in question were periodically sampled, on a frequency which was determined to make some sense in terms of the detection of a depleting storage level within the bin—for example many larger storage bins may take long enough to unload that the necessary sampling frequency might be just every half hour or something along those lines to detect a significant drop in the level of material stored within the band. In any event, a periodic sampling of the readings from the bin sensors would be taken, and local software on the transceiver or remote software at the central monitoring station could monitor the readings of the non-volumetric bin sensors with a view to ascertaining the presence or absence of stored material within the particular volumetric cross-sections of the storage bin in question corresponding to the bin sensors in question. In a circumstance where the stored material volume within the storage bin was calculated to be depleting, or for that matter increasing, rapidly enough that it was measured within the periodic frequency, and alert could be triggered to the user to alert them to the rapid depletion at the site. Theft may not be the only reason that this might take place in fact the rapid depletion of material stored within a storage bin may in fact be because the user or related individuals to the farmer is out emptying the bin, but in any event again based on non-volumetric bin sensors otherwise in place in the bin anyhow, this would provide the ability to have a basic monitoring tool to detect rapid changes in the level of storage within the storage bin or bins in question.

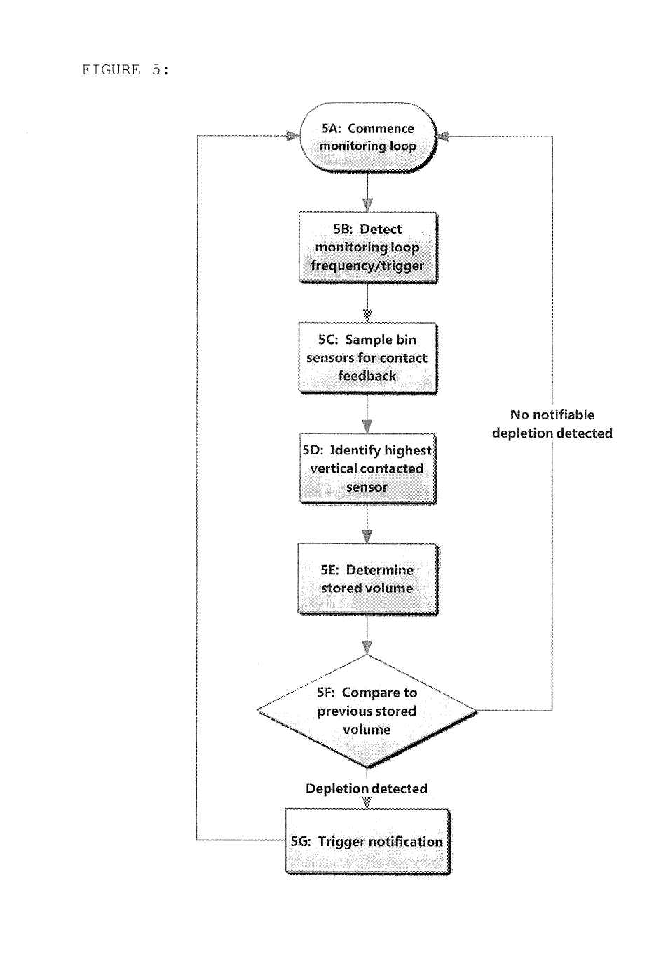

FIG. 5 is a flowchart demonstrating the steps in one embodiment of a rapid change notification method, to notify user of either a rapid depletion which might point to remote theft, or a rapid increase in the contents of the storage bin instrumented with the system and method of the present invention. The method would entail a periodic monitoring loop, within which material volume changes could be determined—for example it might be determined that the appropriate monitoring loop was 30 minutes or anything else relevant from the perspective of sampling the sensors in the bin with a view to identifying rapid volume changes.

Once the frequency or the monitoring loop was determined or defined, it would be commenced as shown at SA. When the monitoring loop frequency or trigger point was reached, shown at SB, the hardware would be used to sample the bin sensors to obtain their non-volumetric attributes for use in a volume storage calculation in accordance with the remainder of either the additive or aggregate method of the present invention. Sampling the sensors is shown at SC.

Based upon the sensor readings obtained at SC, the stored volume within the bin could be determined SD. The stored volume within the bin would then be compared to the last stored volume calculated at the last sampling point and, within whatever programmed parameters were desired, if a depletion or increase were detected then the user could be notified and a new sampling loop commenced. If no volume change had occurred then the method would simply loop back to restarting the monitoring frequency.

Notification parameters might vary by bin, by transceiver or by user, and these varying levels of flexibility in the notification process are all contemplated within the scope of the present invention as well. It is specifically contemplated that where the central monitoring system incorporates a website or other related user interface for reporting purposes, that website system might also allow the user to access and program the threshold level settings for particular bins and transceivers within their implementation of the method as well as the notification parameters associated either at the user level with their account or down to more specific transceivers, sites or bins. Where a website system or similar user interface was used to allow the user to customize their settings for the hardware of the present system, and the user entered alternate threshold data with respect to particular bins on particular transceivers associated with their user account on the system, the central monitoring system could in a two-way communication environment, flash those threshold level changes back to the necessary transceivers for storage and use thereon.

### Transceiver

The transceiver of the present invention would be the remote site hardware that was responsible for aggregation and monitoring of the temperature or other sensor levels within the various bins at that location, which information would also be used indirectly for the calculation of stored volume with any storage bin at that location. The transceiver would be any combination of hardware and software capable of connection and communication with the non-volumetric bin sensors for measuring temperature or other non-volumetric attributes at various zones along the vertical axis of the storage bins at that location.

Specific hardware configuration of the transceiver of the present invention could take many formats so long as the transceiver was capable of communication with and monitoring of the bin sensors in the storage bin or bins at the storage location, and in an outgoing communication embodiment, the transceiver would also need to be capable of outgoing communication with the central monitoring system. The hardware and software of the transceiver would also have programmed or flashable therein, parameters which would be required for capturing the sensor values with relation to particular bin sensors in particular storage bins and the communication of the values captured there from by notification to the remainder of the system and method of the present invention.

The transceiver would include at least one sensor interface capable of connection to the plurality of non-volumetric bin sensors located in at least one storage bin at a location. It is specifically contemplated that either hardwired or wireless temperature sensors could be used within the storage bin and on that basis it may be necessary for the transceiver to include multiple sensor interfaces to read the temperatures of the sensors is required incorporation of multiple sensor interfaces into a transceiver in accordance with the remainder of the present invention would be understandable to those skilled in the art of circuit design and electronics designed in this field and all such modifications or enhancements are contemplated within the scope hereof.

The method of the present invention for the sensor-based calculation of stored volume of material within the storage bin, using a plurality of non-volumetric bin sensors displaced in relation to the vertical axis of the storage bin, could either be used in an unattended remote monitoring application, or could even be practiced in a local storage site, where the arrays of bin sensors within individual storage bins were connected to a transceiver which provided data or feedback at a local site, rather than feeding that information to a remote monitoring location.

As outlined above it is particularly contemplated that the grain bin temperature sensors or bin sensors for measurement of other non-volumetric attributes of the material stored therein could either be connected to the transceiver on a wireless basis or alternatively in a hardwired fashion—or a combination thereof with respect to a single transceiver. While perhaps the simplest implementation or installation of the new system according to the present invention would be the use of wireless non-volumetric bin sensors within a grain bin, which would wirelessly handshake and communicate with the transceiver at the location, the incorporation of a hardwired interface would be particularly useful to allow for the operability of the transceiver and the remainder of the method of the present invention was previously installed hardwired non-volumetric bin sensors.

It is most specifically contemplated that the transceiver would communicate with a central monitoring system. The external network interface might be a wireless modem, such as a cellular modem or the like, capable of sending or receiving IP communications to and from the central monitoring station for that transceiver. There are other types of communication interfaces and protocols between the transceiver and a central monitoring system might also be understood to those skilled in the art, which would not depart from the scope or intention of the present invention and insofar as those are available those are also contemplated within the scope hereof.

Dependent upon the number of channels which the transceiver was capable of monitoring it may be the case that more than one transceiver was required in a particular remote monitoring location.

### Central Monitoring System

Certain embodiments of the system and method of the present invention would rely upon communication of temperature or other sensor information in remotely located storage bins to calculate and present to a remote user an approximation of the volume of stored material within one or more grain storage bins. Some embodiments of the system might simply rely upon the methodology outlined herein in terms of the use of non-volumetric sensor readings from within a storage bin to provide local access to calculated stored material volume within one or more storage bins as well and either approach is contemplated within the scope hereof.

The central monitoring system of the present invention could be programmed with conditions or parameters as to how to action the receipt of a particular sensor reading from a remote monitoring site which would indicate a particular storage volume—or for example might also indicate a rapid depletion of stored material within the storage bin which might indicate theft or some other activity on the remote site of which the user or viewer of the information was not aware of.

In terms of communications infrastructure the central monitoring system would require the necessary hardware and software combination to receive notification messages from the remote transceivers at the remote monitoring sites—which could likely be a wireless IP network interface, but dependent upon the type of modems or other communication hardware used on the transceivers could also comprise any number of other different communication interfaces all of which will be obvious to those skilled in the art and are contemplated within the scope of the present invention.

The second communications interface required by the central monitoring station would be the ability and interface to communicate on an outgoing basis with users on notifications of bin sensor changes or calculated stored material volumes, as required. The central monitoring system might actually include more than one outgoing communications interface if it was desired to provide maximized flexibility to users thereof—for example the system might be capable of dispatching notification messages by SMS text message and or by e-mail message and the necessary hardware and software combination to work in conjunction with the remainder of the infrastructure of the central monitoring system to provide these outgoing communications abilities will be understood by those skilled in the art and again are all obviously contemplated within the scope of the present invention.

### User and Location Database

The central monitoring system of the present invention could include a user and location database, which could take a specific format of any particular data structure or format which was capable of being read, written and interfaced with by the central monitoring system of the present invention. The key aspects of that database would be to maintain the necessary information to generate notifications on behalf of the user if a particular bin sensor and transceiver detected a trigger event occasioning a notification to the user about a stored material volume in that bin. Other data related to the user or the various remote bins and locations of the user could also be stored within such a database to allow for more elaborate or customized reporting.

Finally and as outlined elsewhere above, if the system was configured such that it was desired to allow the user to specify the notification parameters or the detection parameters around trigger events either for individual bins or at their own “user account” level, the database of the central monitoring system could include the necessary structure or components for the user to indicate and store these settings with relation to their user account. In a case such as this where the user was allowed to adjust the notification or detection parameters, it would also be desirable for the central monitoring system of the present invention to be able to send communication to the transceivers at specific remote locations, in addition to receiving trigger notifications therefrom, since adjustments to the detection parameters would likely in an optimized fashion be communicated to and hosted on the transceiver so as to maintain and maximize the optimization of bandwidth consumption in the dispatch of trigger notifications from the transceiver(s) All of these requirements would be understood and met by those skilled in the art of database design and any data structure or database which would store this type of information in a fashion that it was communicably accessible to the remainder of the central monitoring system of the present invention are contemplated within the scope hereof.

### Exemplary Embodiment

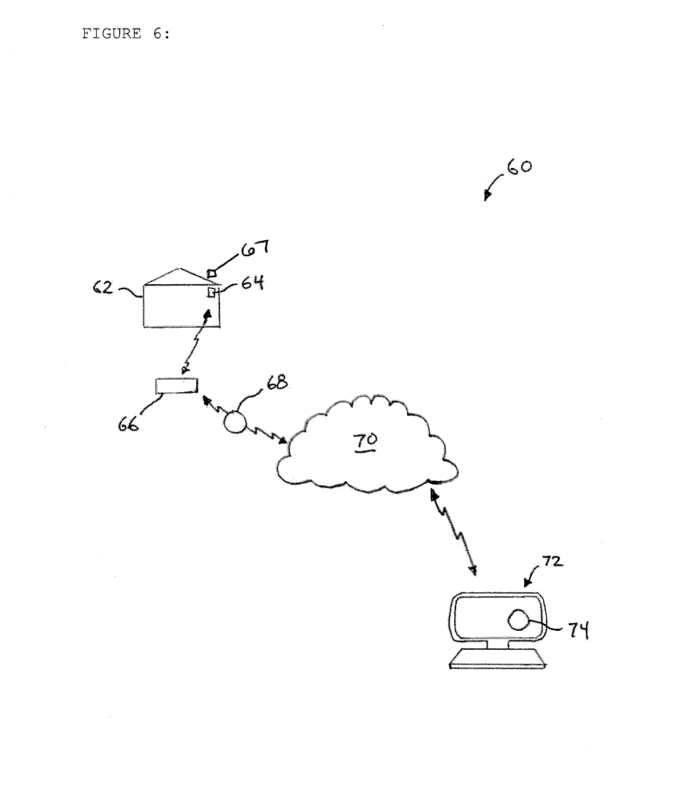

In FIG. 6, a system 60 is illustrated that includes a single bin 62. The bin 62 is provided with a plurality of non-volumetric bin sensors 64 for detecting the temperature within the bin 62. As outlined above, various temperature sensors that can serve this function are commercially available, and one skilled in the art would be able to identify numerous appropriate products.

The system 60 further comprises a transceiver 66 that is configured to receive a signal from at least one in-bin non-volumetric sensor 64 indicating the internal temperature of a zone within the bin 62.

An ambient temperature sensor 67 is provided externally of the internal storage area of the bin where the grain is located for determining ambient temperature used in determining the proximity condition of sensors 64. The ambient temperature sensor 67 communicates with the transceiver 66 by any suitable means.

The transceiver 66 is further configured to communicate in a wired or wireless fashion with a communication network 70 such as the Internet through, for example, a cellular modem, and in turn via the communications networks 70 with a central monitoring station or system 72.

The transceiver 66 functions as a master unit which receives sensed temperatures from the ambient temperature sensor 67 and the in-bin sensors 64 either directly by wired or wireless communication, or through an intermediate remote unit which reports data from a selected sensor or group of sensors to the master unit by wired or wireless communication. In either instance the master unit aggregates data from several sensors for subsequent communication to the server of the central monitoring system.

The transceiver 66 is provided with both a memory storage and a processor. The processor is coupled to the memory storage in a manner known to those skilled in the art. At the central monitoring system 72, an indication 74 of the stored material volume within the bin is displayed.

Although not shown, the system 60 can also include a means for enabling third party access to the received data once it has been sent to the central monitoring system 72. For example the central monitoring system 72 as outlined elsewhere herein might include a website system or other similar user interface, whereby a user or another third party could access the data through the communication network 70 with the use of a password or other security mechanism.

The foregoing is considered as illustrative only of the principles of the invention. Thus, while certain aspects and embodiments of the invention have been described, these have been presented by way of example only and are not intended to limit the scope of the invention, which could for example extend beyond temperature sensors to other types of sensors. Indeed, the invention described herein may be embodied in a variety of other forms without departing from the spirit of the invention, which invention is defined solely by the claims below.

1. A method of monitoring a stored volume of material in a storage bin, the method comprising:
providing at least one non-volumetric bin sensor in the storage bin so as to be arranged to sense a non-volumetric attribute of material stored within the bin by proximity of the sensor to the stored material and a controller in communication with said at least one non-volumetric bin sensor so as to be arranged to receive the non-volumetric attribute sensed by said at least one non-volumetric bin sensor;
determining a proximity condition of said at least one non-volumetric bin sensor relative to the stored material based upon the non-volumetric attribute sensed by the non-volumetric bin sensor;
calculating a stored volume of material within the storage bin based upon the determined proximity condition of said at least one non-volumetric bin sensor and a location of said at least one non-volumetric bin sensor within the storage bin; and
using the controller to transmit one of the sensed non-volumetric attribute of said at least one non-volumetric bin sensor, the proximity condition of said at least one non-volumetric bin sensor, or the calculated stored volume to a monitoring location.

2. The method according to claim 1 wherein said at least one non-volumetric bin sensor comprises a plurality of non-volumetric bin sensors in the storage bin, each at a respective height within the storage bin.

3. The method according to claim 1 wherein said at least one non-volumetric bin sensor comprises a temperature sensor arranged to sense a temperature of the material in the storage bin.

4. The method according to claim 3 wherein said at least one non-volumetric bin sensor comprises a plurality of non-volumetric bin sensors in the storage bin, each at a respective height within the storage bin, and wherein the method further comprises determining a proximity condition of each sensor relative to the stored material by comparing the sensed temperature to the sensed temperature of other sensors.

5. The method according to claim 3 wherein the method further comprises determining a proximity condition of said at least one non-volumetric bin sensor by comparing the sensed non-volumetric attribute to a proximity criterion.

6. The method according to claim 1 including using the controller to periodically sample the non-volumetric attribute sensed by said at least one non-volumetric attribute.

7. The method according to claim 6 including transmitting either one of the sensed non-volumetric attribute of said at least one non-volumetric bin sensor, the proximity condition of said at least one non-volumetric bin sensor or the calculated stored volume to the monitoring location only if the sensed non-volumetric attribute of said at least one non-volumetric bin sensor has changed by a prescribed criterion amount.

8. The method according to claim 1 including providing a monitoring system at the monitoring location arranged to communicate with the controller, and using the monitoring system to send a notification signal to a user in response to a change in the proximity condition of said at least one non-volumetric bin sensor.

9. The method according to claim 1 including providing a monitoring system at the monitoring location arranged to communicate with the controller, and using the controller to sample the non-volumetric attribute sensed by said at least one non-volumetric attribute, and determining the proximity condition of said at least one non-volumetric bin sensor in response to a query signal from the monitoring system.

10. The method according to claim 1 wherein the monitoring location comprises a user location associated with a single user.

11. The method according to claim 10 further comprising using the controller to calculate the stored volume of material and transmitting the calculated stored volume of material to the single user at the user location.

12. The method according to claim 1 wherein the monitoring location comprises a central monitoring system at a central location associated with a plurality of users, each having at least one storage bin arranged to be monitored by the central monitoring system at the central location.

13. The method according to claim 12 further comprising using the central monitoring system to both determine the proximity condition of said at least one non-volumetric bin sensor and to calculate the stored volume of material and transmitting the calculated stored volume of material to the single user at the user location.

14. The method according to claim 12 further comprising using the controller to calculate the stored volume of material and transmitting the calculated stored volume of material to the central monitoring system at the central location.

15. The method according to claim 12 further comprising transmitting either one of the sensed non-volumetric attribute or the proximity condition of said at least one non-volumetric bin sensor to the central monitoring system, and using the central monitoring system to calculate the stored volume of material.

16. The method according to claim 1 further comprising associating a prescribed volume with said at least one non-volumetric bin sensor and calculating the stored volume using the proximity condition and the prescribed volume of said at least one non-volumetric bin sensor.

17. The method according to claim 1 further comprising associating a prescribed height with said at least one non-volumetric bin sensor and calculating the stored volume using the proximity condition of said at least one non-volumetric bin sensor, the prescribed volume of said at least one non-volumetric bin sensor, and a cross-sectional area of the bin.

18. A monitoring system for monitoring a stored volume of material in a storage bin, the system comprising:
at least one non-volumetric bin sensor in the storage bin so as to be arranged to sense a non-volumetric attribute of material stored within the bin by proximity of the sensor to the stored material;
a monitoring system;
a controller including a memory storage and a processor configured to receive a signal from said at least one non-volumetric bin sensor indicating the non-volumetric attribute sensed by said at least one non-volumetric bin sensor and configured to transmit the sensed non-volumetric attribute of said at least one non-volumetric bin sensor to the monitoring system;
one of the monitoring system and the controller being further configured to determine a proximity condition of said at least one non-volumetric bin sensor relative to the stored material based upon the non-volumetric attribute sensed by the non-volumetric bin sensor and to calculate a stored volume of material within the storage bin based upon the determined proximity condition of said at least one non-volumetric bin sensor and a location of said at least one non-volumetric bin sensor within the storage bin.

19. The system according to claim 18 wherein said at least one non-volumetric bin sensor comprises a plurality of non-volumetric bin sensors in the storage bin, each at a respective height within the storage bin.

20. The system according to claim 18 wherein said at least one non-volumetric bin sensor comprises a temperature sensor arranged to sense a temperature of the material in the storage bin.
